(19) United States
(12) Patent Application Publication
(10) Pub. No.: US 2014/0351887 A1
(43) Pub. Date: Nov. 27, 2014

(54) Authentication Method and Device for Network Access

(71) Applicant: Huawei Technologies Co., Ltd., Shenzhen (CN)

(72) Inventor: Qiming Liu, Shanghai (CN)

(21) Appl. No.: 14/336,775

(22) Filed: Jul. 21, 2014

Related U.S. Application Data
(63) Continuation of application No. PCT/CN2013/070786, filed on Jan. 21, 2013.

(30) Foreign Application Priority Data
Jan. 21, 2012 (CN) 201210019801.3

(51) Int. Cl. H04W 12/06; H04L 29/06

(52) U.S. Cl. CPC H04W 12/06; H04L 63/0876
USPC 726/3

(57) ABSTRACT

Embodiments of the present invention disclose an authentication method and device for network access. In the authentication method for network access in the embodiments, a first radio access network device establishes a data transmission channel of a first radio access network with a user equipment, obtains identification information of the user equipment in a second radio access network, and generates authentication information which is of the second radio access network and corresponds to the identification information, where the authentication information includes authentication information which is of the second radio access network and is for the user equipment and a second radio access network device to use; and sends the authentication information for the user equipment to use to the user equipment, and send correspondence between the identification information and the authentication information for the second radio access network device to use to the second radio access network device.

This application is a continuation of International Application No. PCT/CN2013/070786, filed on Jan. 21, 2013, which claims priority to Chinese Patent Application No. 201210019801.3, filed on Jan. 21, 2012, both of which are hereby incorporated by reference in their entireties.

### TECHNICAL FIELD

The present invention relates to the field of communications technologies and, in particular embodiments, to an authentication method and device for network access.

### BACKGROUND

In a radio access network such as a wireless local area network (WLAN), in order to solve a problem of network security, a unified authentication method is generally adopted to perform authentication on a user in the radio access network. In this way, a user equipment may use a user name and a token to log in to and access a network system to which the user equipment is allowed to log in. An existing unified authentication method includes an authentication manner of an extensible authentication protocol method for GSM subscriber identity module (EAP-SIM), a portal authentication manner, an authentication method based on a Wi-Fi protected access pre-shared key (WPA-PSK), and the like.

For example, when the WPA-PSK method is adopted to perform authentication, a same shared key needs to be configured first in a wireless device end (such as an access point) and a user equipment. The wireless device end broadcasts a message to initiate an authentication process, and after several handshakes, the wireless device end and the user equipment perform interaction on necessary information for calculating a message integrity code (MIC). The wireless device end and the user equipment separately use a same algorithm to calculate a MIC according to the received necessary information, the preset shared key and local information. Finally, the user equipment sends the calculated MIC to the wireless device end. If the MICs separately calculated by the user equipment and the wireless device end are consistent, the authentication succeeds, otherwise the authentication fails.

A precondition of the existing authentication is that authentication information needs to be configured in both an authentication end and a user equipment. For example, a premise for performing WPA-PSK authentication is that authentication information, such as a same shared key and a same algorithm, needs to be preconfigured in a wireless device end and the user equipment. In this way, the authentication information is easily leaked. If the authentication information is leaked, the authentication end and the user equipment need to be reconfigured manually, which is tedious.

### SUMMARY

Embodiments of the present invention provide an authentication method and device for network access, so as to improve security of network access authentication.

In one aspect, an authentication method for network access is provided and includes: establishing a data transmission channel of a first radio access network with a user equipment, where the user equipment supports the first radio access network and a second radio access network; obtaining identification information of the user equipment in the second radio access network, and generating authentication information which is of the second radio access network and corresponds to the identification information, where the authentication information includes authentication information which is of the second radio access network and is for the user equipment to use and authentication information which is of the second radio access network and is for a second radio access network device to use; and sending the authentication information which is of the second radio access network and is for the user equipment to use to the user equipment through the established data transmission channel of the first radio access network, and sending correspondence between the identification information and the authentication information which is of the second radio access network and is for the second radio access network device to use to the second radio access network device.

In another aspect, an authentication method for network access is provided and includes: establishing a data transmission channel of a first radio access network with a first radio access network device; sending identification information of a user equipment in a second radio access network to the first radio access network device; receiving authentication information which is of the second radio access network, corresponds to the identification information, is for the user equipment to use, and is returned by the first radio access network device; and performing access authentication of the second radio access network according to the received authentication information.

In another aspect, a radio access network device is provided. A channel establishing unit is configured to establish a data transmission channel of a first radio access network with a user equipment. The user equipment supports the first radio access network and a second radio access network. An authentication generating unit is configured to obtain identification information of the user equipment in the second radio access network and to generate authentication information which is of the second radio access network and corresponds to the identification information. The authentication information includes authentication information which is of the second radio access network and is for the user equipment to use and authentication information which is of the second radio access network and is for a second radio access network device to use. An authentication sending unit is configured to send the authentication information which is of the second radio access network and is for the user equipment to use to the user equipment through the data transmission channel which is of the first radio access network and is established by the channel establishment unit, and to send correspondence between the identification information and the authentication information which is of the second radio access network and is for the second radio access network device to use to the second radio access network device.

In another aspect, a user equipment is provided. A data channel establishing unit is configured to establish a data transmission channel of a first radio access network with a first radio access network device. An information sending unit is configured to send identification information of the user equipment in a second radio access network to the first radio access network device. An authentication receiving unit is configured to receive authentication information which is of the second radio access network, corresponds to the identification information, is for the user equipment to use, and is returned by the first radio access network device. An authentication unit is configured to perform access authentication of the second radio access network according to the authentication information received by the authentication receiving unit.

In technical solutions of network access authentication of the embodiments, the first radio access network device establishes the data transmission channel of the first radio access network with the user equipment, obtains the identification information of the user equipment in the second radio access network, and generates the authentication information which is of the second radio access network and corresponds to the identification information, where the authentication information includes the authentication information which is of the second radio access network and is for the user equipment and the second radio access network device to use; sends the authentication information which is of the second radio access network and is for the user equipment to use to the user equipment through the established data transmission channel of the first radio access network, and sends the correspondence between the identification information and the authentication information which is of the second radio access network and is for the second radio access network device to use to the second radio access network device, and the user equipment and the second radio access network device may perform authentication of the second radio access network according to the authentication information. In this way, the authentication information for performing the authentication of the second radio access network no longer needs to be fixedly saved in the user equipment and the second radio access network device, but may be dynamically allocated by the first radio access network, so that the authentication information for performing network access authentication is not easily leaked, thereby improving security of network access authentication.

### BRIEF DESCRIPTION OF THE DRAWINGS

To illustrate the technical solutions in the embodiments of the present invention more clearly, accompanying drawings required for describing the embodiments are introduced briefly in the following. Apparently, the accompanying drawings in the following description are only some embodiments of the present invention, and persons of ordinary skill in the art may further derive other drawings according to these accompanying drawings without creative efforts.

FIG. 1 is a flowchart of an authentication method for network access according to an embodiment of the present invention;

FIG. 2 is a flowchart of another authentication method for network access according to an embodiment of the present invention;

FIG. 3 is a flowchart of another authentication method for network access according to an embodiment of the present invention;

FIG. 4 is a flowchart of an authentication method for network access in a specific application according to an embodiment of the present invention;

FIG. 5 is a flowchart of an authentication method for network access in another specific application according to an embodiment of the present invention;

FIG. 6 is a schematic structural diagram of a radio access network device according to an embodiment of the present invention; and

FIG. 7 is a schematic structural diagram of a user equipment according to an embodiment of the present invention.

### DETAILED DESCRIPTION OF ILLUSTRATIVE EMBODIMENTS

The following clearly describes the technical solutions in the embodiments of the present invention with reference to the accompanying drawings in the embodiments of the present invention. Obviously, the embodiments to be described are only a part rather than all of the embodiments of the present invention. All other embodiments obtained by persons of ordinary skill in the art based on the embodiments of the present invention without creative efforts shall fall within the protection scope of the present invention.

An embodiment of the present invention provides an authentication method for network access, which may perform authentication on a user equipment that supports various types of radio access networks, where the various types of radio access networks, for example, may include such types of networks as a cellular network and a WLAN. The cellular network, for example, may be a network such as a universal mobile telecommunications system (UMTS), a global system of mobile communication (GSM) or long term evolution (LTE).

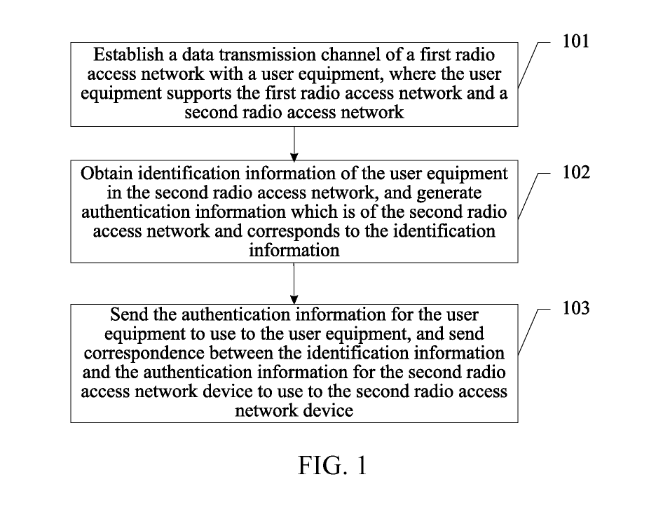

The method in the embodiment of the present invention is a method executed by a first radio access network device, and a flowchart is shown in FIG. 1. The method includes the following steps.

Step 101: Establish a data transmission channel of a first radio access network with a user equipment, where the user equipment supports the first radio access network and a second radio access network.

Specifically, in this embodiment, when initiating a service of the second radio access network, the user equipment cannot access the second radio access network until authorization and authentication between the user equipment and a second radio access network device succeed. However, a method such as key authentication, password authentication, identity authentication or certificate authentication is generally adopted during the authentication, so authentication information needs to be configured in both the user equipment and the second radio access network device. For example, for a WPA-PSK authentication method, authentication information, such as a same shared key and authentication algorithm, needs to be configured between the user equipment and the second radio access network device (such as an authentication server), thereby performing authentication according to the authentication information.

The authentication information refers to authentication relevant information that needs to be configured in both the user equipment and the second radio access network device in an authentication process of accessing the second radio access network, and may specifically be information such as a password for performing password authentication, or an identity number for performing identity authentication, or a certificate for performing certificate authentication, or a shared key or a private key for calculating an authentication file, such as a message integrity code, or an algorithm for a user equipment and a second radio access network device to calculate an authentication file.

In this embodiment, the authentication information is dynamically allocated by a device of the first radio access network supported by the user equipment, and the first radio access network device needs to first establish a data transmission channel with the user equipment. Specifically, the user equipment may send a connection establishment request to the first radio access network device, and after a process of mutual authentication and authorization is completed, and when the user equipment initiates a service of the first radio access network, the data transmission channel may be established, which may specifically be a user plane transmission channel.

Step 102: Obtain identification information of the user equipment in the second radio access network, and generate authentication information which is of the second radio access network and corresponds to the identification information, where the authentication information may include authentication information which is of the second radio access network and is for the user equipment to use and authentication information which is of the second radio access network and is for the second radio access network device to use, and the authentication information for the user equipment to use and the authentication information for the second radio access network device to use may be the same, and may also be different.

Specifically, after the first radio access network device establishes the data transmission channel of the first radio access network with the user equipment, if the user equipment initiates access of the second radio access network again, the user equipment may report the identification information of the user equipment in the second radio access network through interaction with the first radio access network device.

For example, the user equipment may initiate a request message to the first radio access network device to obtain information for performing authentication of the second radio access network, and the request message may carry the identification information of the user equipment in the second radio access network, for example, information that may uniquely identify the user equipment, such as a user identifier or a media access control (MAC) address of the second radio access network. After receiving the request message, the first radio access network device may parse the request message to obtain the identification information of the user equipment in the second radio access network, and may generate, according to a preset policy, the authentication information which is of the second radio access network and corresponds to the identification information, for example, may randomly generate one piece of authentication information and associate the authentication information with the identification information, or perform calculation on the identification information according to a certain algorithm and generate one piece of authentication information. Here, how to generate the authentication information does not constitute a limitation to the present invention.

In this embodiment, the authentication information generated by the first radio access network device may include authentication information which is of the second radio access network and is for the user equipment to use and authentication information which is of the second radio access network and is for the second radio access network device to use, where the authentication information for the user equipment to use and the authentication information for the second radio access network device to use may be the same, for example, information such as a shared key, a certificate, an identity number or a password; or the authentication information for the user equipment to use and the authentication information for the second radio access network device to use may also be different, for example, information such as a private key.

Step 103: Send the authentication information which is of the second radio access network and is for the user equipment to use to the user equipment through the data transmission channel which is of the first radio access network and is established in step 101, and send correspondence between the identification information and the authentication information which is of the second radio access network and is for the second radio access network device to use to the second radio access network device.

Specifically, the first radio access network device may correspondingly send the authentication information generated in step 102 to the user equipment and the second radio access network device, so that the user equipment and the second radio access network device save the authentication information which is of the second radio access network and is dynamically allocated by the first radio access network device, thereby performing access authentication of the second radio access network. For example, the first radio access network device may send the generated authentication information which is of the second radio access network and is for the user equipment to use to the user equipment through the data transmission channel established in step 101, for example, may send the generated authentication information which is of the second radio access network and is for the user equipment to use to the user equipment for storage by carrying the generated authentication information which is of the second radio access network and is for the user equipment to use in a user plane message, a control plane message or a short message; while in this embodiment, there is an interface for communication between radio access network devices, and the first radio access network device may send the correspondence between the generated authentication information for the second radio access network device to use and the identification information to the second radio access network device for storage through an interface with the second radio access network device.

In this way, if the user equipment accesses the second radio access network, the second radio access network device may find the stored authentication information which is of the second radio access network and corresponds to the identification information of the user equipment, and perform access authentication of the second radio access network with the user equipment according to the found authentication information, such as password authentication, certificate authentication, key authentication or identity authentication. Specifically, for the key authentication, the user equipment and the second radio access network device separately calculate a MIC according to their respective stored authentication information. If the MIC obtained through calculation by the user equipment is consistent with the MIC calculated by the second radio access network device, the authentication succeeds, otherwise the authentication fails.

In this embodiment, the first radio access network and the second radio access network do not represent a sequence relationship, but indicate a difference of radio access networks. For example, the first radio access network may be a cellular network, such as UMTS, GSM or LTE, and the second radio access network may be a WLAN; while the first radio access network device, for example, may be a radio network controller (RNC) in a UMTS network, and the second radio access network device, for example, may be a device, such as an access point (AP) or an access controller (AC) or a base station in a WLAN. Definitely, the first radio access network and the second radio access network may be any other two radio access networks.

It can be seen that, in the authentication method for network access in this embodiment, the first radio access network device establishes the data transmission channel of the first radio access network with the user equipment, obtains the identification information of the user equipment in the second radio access network, and generates the authentication information which is of the second radio access network and corresponds to the identification information, where the authentication information includes the authentication information which is of the second radio access network and is for the user equipment and the second radio access network device to use; sends the authentication information which is of the second radio access network and is for the user equipment to use to the user equipment through the established data transmission channel of the first radio access network, and sends the correspondence between the identification information and the authentication information which is of the second radio access network and is for the second radio access network device to use to the second radio access network device, and the user equipment and the second radio access network device may perform authentication of the second radio access network according to the authentication information. In this way, the authentication information for performing the authentication of the second radio access network no longer needs to be fixedly saved in the user equipment and the second radio access network device, but may be dynamically allocated by the first radio access network, so that the authentication information for performing network access authentication is not easily leaked, thereby improving security of network access authentication.

It should be noted that, in the embodiment, optionally, the user equipment and the second radio access network device may not pre-save the authentication information of the second radio access network, such as a shared key, a private key or an algorithm of an authentication file. Each time when the user equipment accesses the second radio access network, the first radio access network device dynamically allocates the authentication information to the user equipment and the second radio access network device, thereby performing a process of the authentication of the second radio access network; or, optionally, the user equipment and the second radio access network device may also pre-save the authentication information of the second radio access network. However, the authentication information may be updated periodically, so before executing step 102 to generate the authentication information, the first radio access network device first needs to determine whether the authentication information pre-saved in the user equipment and the second radio access network device needs to be updated, if yes, executes step 102 to generate the authentication information, and if not, ends the procedure.

Specifically, for example, when the first radio access network device is started, or establishes the data transmission channel with the user equipment, a timer may be started, where timing time of the timer may be set according to a period in which the user equipment and the second radio access network device update the stored authentication information, or may also be set according to an actual requirement. After obtaining the identification information, the first radio access network device first determines whether a preset timer is triggered. If yes, it indicates that the authentication information stored in the user equipment and the second radio access network device needs to be updated, so the first radio access network device dynamically allocates the authentication information to the user equipment and the second radio access network device for storage, and if not, the procedure is ended. For another example, when the first radio access network device is started, or establishes the data transmission channel with the user equipment, a time counter may also be started, where timeout time of the time counter may be set according to a period in which the user equipment and the second radio access network device update the stored authentication information, or definitely, may also be set according to an actual requirement. After obtaining the identification information, the first radio access network device may first determine whether a preset time counter expires. If yes, the authentication information may be dynamically allocated to the user equipment and the second radio access network device for storage, and if not, the procedure is ended.

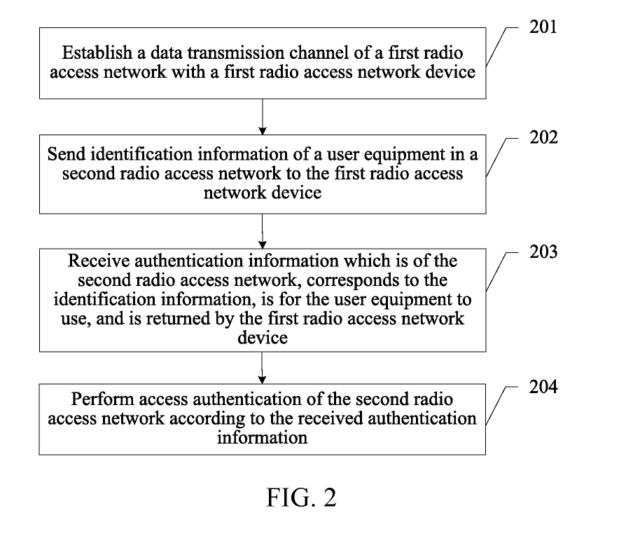

An embodiment of the present invention further provides another authentication method for network access, which may perform authentication on a user equipment that supports various types of radio access networks, where the various types of radio access networks, for example, may include such types of networks as a cellular network and a WLAN. The cellular network, for example, may be a network such as UMTS, GSM or LTE. The method in this embodiment is a method executed by a user equipment, the user equipment supports a first radio access network and a second radio access network, and a flowchart is shown in FIG. 2, where the method includes:

Step 201: Establish a data transmission channel of a first radio access network with a first radio access network device.

Specifically, in this embodiment, when initiating a service of the second radio access network, the user equipment cannot access the second radio access network until authorization and authentication with a second radio access network device succeed. However, a method such as password authentication, identity authentication, certificate authentication or key authentication is generally adopted in an authentication process. Specifically, for example, for a WPA-PSK authentication method, same authentication information needs to be configured between the user equipment and the second radio access network device, thereby performing authentication according to the authentication information.

The authentication information refers to authentication relevant information that needs to be configured in the user equipment and the second radio access network device in an authentication process of accessing the second radio access network, and may specifically be information such as a password for performing password authentication, or an identity number for performing identity authentication, or a certificate for performing certificate authentication, or a shared key or a private key for calculating an authentication file, such as a message integrity code, or an algorithm for a user equipment and a second radio access network device to calculate an authentication file.

In this embodiment, the authentication information is allocated by a device of the first radio access network supported by the user equipment, and the user equipment needs to first establish a data transmission channel with the first radio access network device. Specifically, the user equipment sends a connection establishment request to the first radio access network device, and after a process of mutual authentication and authorization is completed, and when the user equipment initiates a service of the first radio access network, the data transmission channel may be established, which may specifically be a user plane transmission channel.

Step 202: Send identification information of the user equipment in the second radio access network to the first radio access network device.

Specifically, the user equipment may send the identification information through interaction with the second radio access network device, for example, the user equipment may actively initiate a request message to the first radio access network device to report the identification information, and the request message may carry the identification information of the user equipment in the second radio access network, for example, information that may uniquely identify the user equipment, such as a user identifier or a MAC address of the second radio access network.

Step 203: Receive authentication information which is of the second radio access network, corresponds to the identification information, is for the user equipment to use, and is returned by the first radio access network device.

Specifically, after receiving the identification information sent by the user equipment, the first radio access network device generates the authentication information which is of the second radio access network and corresponds to the identification information, where the authentication information may include authentication information which is of the second radio access network and is for the user equipment to use and authentication information which is of the second radio access network and is for the second radio access network device to use, and sends the authentication information for the user equipment to use to the user equipment through the established data transmission channel, so the user equipment receives the sent authentication information. A specific process for the first radio access network device to generate the authentication information and send the authentication information is as described in the embodiment corresponding to FIG. 1, and is not repeatedly described.

Step 204: When the second radio access network is accessed, perform access authentication of the second radio access network with the second radio access network device according to the authentication information received in step 203, such as password authentication, identity authentication, key authentication or certificate authentication, where the second radio access network device stores correspondence which is between the identification information and the authentication information which is of the second radio access network and is for the second radio access network device to use and is sent by the first radio access network device.

Specifically, it should be understood that, in this embodiment, the authentication information for the user equipment to use and the authentication information for the second radio access network device to use may be the same, for example, information such as a shared key, a certificate, an identity number or a password; or the authentication information for the user equipment to use and the authentication information for the second radio access network device to use may also be different, for example, information such as a private key.

Specifically, for example, for the key authentication, the user equipment and the second radio access network device may separately calculate a MIC according to the authentication information. If the MIC calculated by the user equipment is consistent with the MIC calculated by the second radio access network device, the authentication succeeds, otherwise the authentication fails.

In this embodiment, the first radio access network and the second radio access network do not represent a sequence relationship, but indicate a difference of radio access networks. For example, the first radio access network may be a cellular network, such as UMTS, GSM or LTE, and the second radio access network may be a WLAN; while the first radio access network device, for example, may be a radio network controller in a UMTS network, and the second radio access network device, for example, may be a device, such as an access point or an access controller or a base station in a WLAN. Definitely, the first radio access network and the second radio access network may be any other two radio access networks.

It can be seen that, in the authentication method for network access in this embodiment, the first radio access network device establishes the data transmission channel of the first radio access network with the user equipment, obtains the identification information of the user equipment in the second radio access network, and generates the authentication information which is of the second radio access network and corresponds to the identification information, where the authentication information includes the authentication information which is of the second radio access network and is for the user equipment and the second radio access network device to use; sends the authentication information which is of the second radio access network and is for the user equipment to use to the user equipment through the established data transmission channel of the first radio access network, and sends the correspondence between the identification information and the authentication information which is of the second radio access network and is for the second radio access network device to use to the second radio access network device, and the user equipment and the second radio access network device may perform authentication of the second radio access network according to the authentication information. In this way, the authentication information for performing the authentication of the second radio access network no longer needs to be fixedly saved in the user equipment and the second radio access network device, but may be dynamically allocated by the first radio access network, so that the authentication information for performing network access authentication is not easily leaked, thereby improving security of network access authentication.

It should be noted that, in the embodiment, optionally, the user equipment and the second radio access network device may not pre-save the authentication information of the second radio access network, such as a shared key, a private key or an algorithm of an authentication file. Each time when the user equipment accesses the second radio access network, the first radio access network device dynamically allocates the authentication information to the user equipment and the second radio access network device, thereby performing a process of the authentication of the second radio access network; or, optionally, the user equipment and the second radio access network device may also pre-save the authentication information of the second radio access network. However, the authentication information may be updated periodically, so before generating the authentication information, the first radio access network device first needs to determine whether the authentication information pre-saved in the user equipment and the second radio access network device needs to be updated, if yes, generates the authentication information, and if not, ends the procedure. Specifically, for example, whether update is needed may be determined through a timer or a time counter, and a specific process is as described in the embodiment corresponding to FIG. 1, and is not repeatedly described.

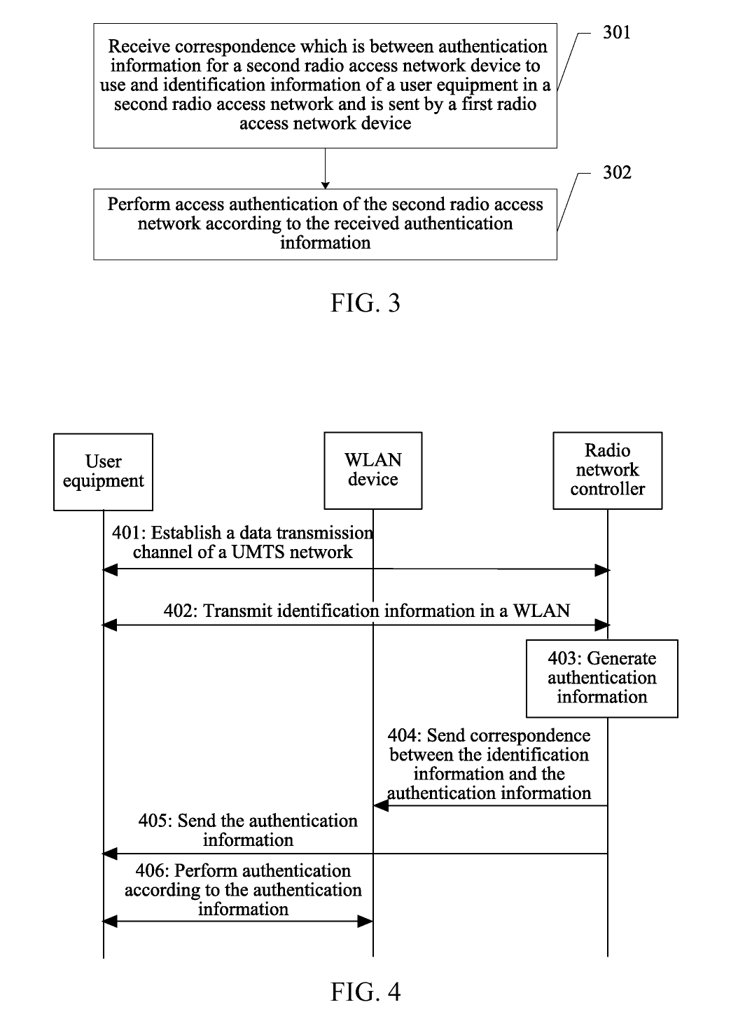

An embodiment of the present invention further provides another authentication method for network access, which may perform authentication on a user equipment that supports various types of radio access networks, where the various types of radio access networks, for example, may include such types of networks as a cellular network and a WLAN. The cellular network, for example, may be a network, such as UMTS, GSM or LTE. The method in this embodiment is a method executed by a second radio access network device, and a flowchart is shown in FIG. 3, where the method includes:

Step 301: Receive correspondence which is between authentication information which is of a second radio access network and is for the second radio access network device to use and identification information of a user equipment in the second radio access network and is sent by a first radio access network device.

Specifically, it should be understood that, after a data transmission channel is established between the first radio access network device and the user equipment, the identification information of the user equipment in the second radio access network may be obtained, for example, information such as a MAC address in the second radio access network, and authentication information which is of the second radio access network and corresponds to the obtained identification information may be generated. The authentication information may include authentication information which is of the second radio access network and is for the user equipment to use and the authentication information which is of the second radio access network and is for the second radio access network device to use. The first radio access network device sends the correspondence between the authentication information for the second radio access network device to use and the identification information to the second radio access network device through an interface with the second radio access network device. A specific process for the first radio access network device to generate the authentication information and send the authentication information is as described in the embodiment corresponding to FIG. 1, and is not repeatedly described.

The authentication information refers to authentication relevant information that needs to be configured in both the user equipment and the second radio access network device in an authentication process of accessing the second radio access network, and may specifically be information such as a password for performing password authentication, or an identity number for performing identity authentication, or a certificate for performing certificate authentication, or a shared key or a private key for calculating an authentication file, such as a message integrity code, or an algorithm for a user equipment and a second radio access network device to calculate an authentication file. The authentication information for the user equipment to use and the authentication information for the second radio access network device to use may be the same, for example, information such as a shared key, a certificate, an identity number or a password; or, the authentication information for the user equipment to use and the authentication information for the second radio access network device to use may also be different, for example, information such as a private key.

Step 302: According to the correspondence which is between the authentication information and the identification information and is received in step 301, perform access authentication of the second radio access network on the user equipment, for example, perform password authentication, identity authentication, key authentication or certificate authentication.

Specifically, when the user equipment accesses the second radio access network, the second radio access network device may find, according to the received the correspondence, the authentication information which is of the second radio access network, is for the second radio access network device to use, and corresponds to the identification information of the user equipment, and perform access authentication of the second radio access network on the user equipment according to the found authentication information, such as password authentication, certificate authentication, key authentication or identity authentication. Specifically, an authentication process is as described in the embodiments corresponding to FIG. 1 and FIG. 2, and is not repeatedly described.

In this embodiment, the first radio access network and the second radio access network do not represent a sequence relationship, but indicate a difference of radio access networks. For example, the first radio access network may be a cellular network, such as UMTS, GSM or LTE, and the second radio access network may be a WLAN; while the first radio access network device, for example, may be a radio network controller in a UMTS network, and the second radio access network device, for example, may be a device, such as an access point or an access controller or a base station in a WLAN. Definitely, the first radio access network and the second radio access network may be any other two radio access networks.

It can be seen that, in the authentication method for network access in this embodiment, the first radio access network device establishes the data transmission channel of the first radio access network with the user equipment, obtains the identification information of the user equipment in the second radio access network, and generates the authentication information which is of the second radio access network and corresponds to the identification information, where the authentication information includes the authentication information which is of the second radio access network and is for the user equipment and the second radio access network device to use; sends the authentication information which is of the second radio access network and is for the user equipment to use to the user equipment through the established data transmission channel of the first radio access network, and sends the correspondence between the identification information and the authentication information which is of the second radio access network and is for the second radio access network device to use to the second radio access network device, and the user equipment and the second radio access network device may perform authentication of the second radio access network according to the authentication information. In this way, the authentication information for performing the authentication of the second radio access network no longer needs to be fixedly saved in the user equipment and the second radio access network device, but may be dynamically allocated by the first radio access network, so that the authentication information for performing network access authentication is not easily leaked, thereby improving security of network access authentication.

The method in the embodiment of the present invention is illustrated through a specific application example in the following. In this embodiment, a first radio access network is a UTMS network, a second radio access network is a WLAN, and no authentication information is pre-stored in a user equipment and a WLAN device. Specifically, referring to FIG. 4, an authentication method for network access in this embodiment includes:

Step 401: A user equipment (UE) establishes a data transmission channel of a UMTS network with an RNC.

Specifically, for example, the UE may send a radio resource control protocol (RRC) connection establishment request to the RNC of the UMTS network, establish an RRC connection through signaling interaction between the RNC and the UE, and then, complete authentication and authorization of the UMTS network. When the UE initiates a service of the UMTS network, establishment of a user plane data transmission channel is completed between the RNC and the UE through signaling interaction. The UE may send an RRC connection establishment request to the RNC, for example, through client software provided by an operator.

Step 402: The UE performs communication with the RNC and transmits identification information of the UE in the WLAN.

Specifically, for example, the UE may create a socket (Socket) for describing an Internet protocol (IP) address and a port number, and send a request message to the RNC through a corresponding port, where the request message includes the identification information of the UE in the WLAN, such as a WLAN MAC address.

Step 403: The RNC receives the identification information reported by the UE, and generates authentication information which is of the WLAN network and corresponds to the identification information.

Specifically, in this embodiment, WLAN network authentication information for the UE to use and WLAN network authentication information for the WLAN device to use may be generated. The WLAN network authentication information for the UE to use and the WLAN network authentication information for the WLAN device to use may be the same, such as a shared key or an authentication algorithm. The WLAN device may be a device such as an access controller (AC) or an AP or a base station.

Step 404: The RNC sends correspondence between the WLAN network authentication information which is for the WLAN device to use and is generated in step 403 and the identification information to the WLAN device for storage through an interface with the WLAN device.

Specifically, for example, the RNC may directly send the correspondence to an AP through an interface with the AP, the RNC may also first send the correspondence to an AC through an interface with the AC, and then the AC forwards the correspondence to the AP. In this case, the UE and the AP perform authentication of WLAN network access; and the RNC may also send the correspondence to the AC, and the AC and the UE perform authentication of WLAN network access.

Step 405: The RNC sends the WLAN network authentication information which is for the UE to use and is generated in step 403 to the UE for storage through the data transmission channel established in step 401.

Specifically, for example, the authentication information may be carried in a user plane message, a control plane message or a short message and sent to the UE.

Step 406: The UE configures an authentication file of the WLAN after receiving the authentication information sent by the RNC, starts a WLAN function, and performs authentication of the user equipment accessing the WLAN network.

Specifically, for example, if the WLAN network authentication information for the UE to use and the WLAN network authentication information for the WLAN device to use are the same, for example, are a same shared key, or same algorithm information for calculating a MIC, when authentication is performed, the WLAN device may initiate a WPA-PSK authentication process, and after several handshakes, the WLAN device and the UE perform interaction on necessary information for calculating a MIC. The WLAN device and the UE separately calculate a MIC by using a same algorithm according to the obtained necessary information for calculating a MIC, the shared key and local information. Finally, the UE sends the calculated MIC to the WLAN device. If it is determined that the MICs separately calculated by the UE and the WLAN device are consistent, the authentication succeeds, otherwise the authentication fails.

In this embodiment, the UE first accesses the UMTS network, and the RNC dynamically allocates same authentication information to the UE and the WLAN device to perform authentication of WLAN network access, for example, WPA-PSK authentication, so that the authentication information is not easily leaked, thereby improving security.

It should be understood that, optionally, in the foregoing embodiment, the WLAN network authentication information which is for the UE to use and is allocated by the RNC and the WLAN network authentication information which is for the WLAN device to use and is allocated by the RNC may also be different.

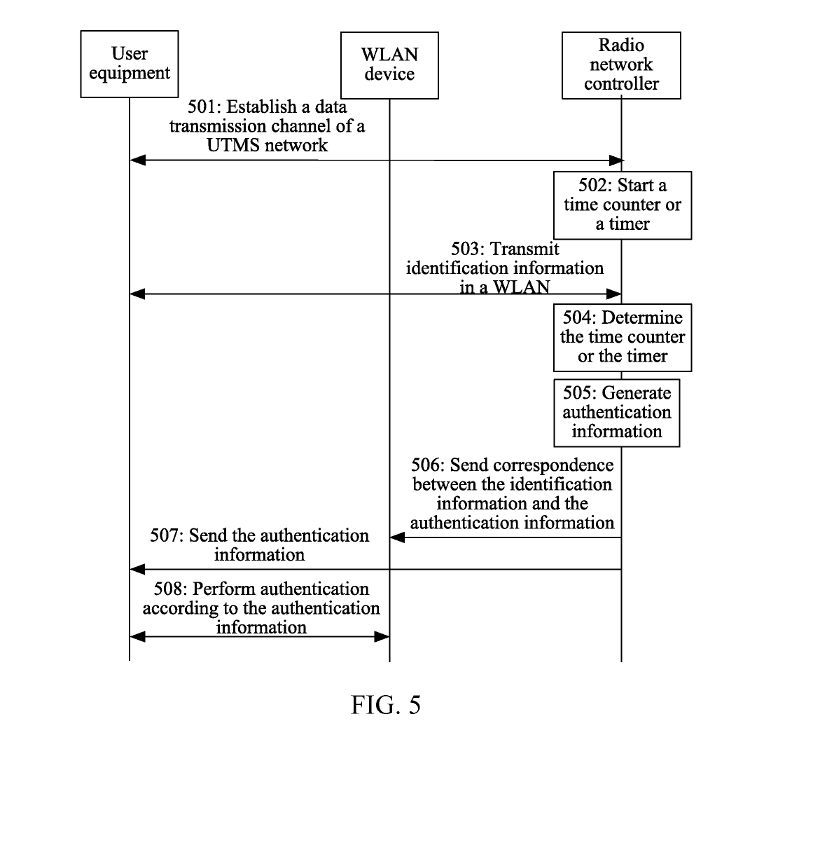

The method in the embodiment of the present invention is illustrated through a specific application example in the following. In this embodiment, a first radio access network is a UTMS network, a second radio access network is a WLAN, and authentication information is pre-stored in a user equipment and a WLAN device. Optionally, the authentication information may be updated periodically. Specifically, referring to FIG. 5, in this embodiment, an authentication method for network access includes the following steps.

Step 501: A UE establishes a data transmission channel of a UTMS network with an RNC.

Specifically, an establishment process is as described in the foregoing step 401, and is not repeatedly described.

Step 502: The RNC may start a timer or a time counter, where timing time of the timer or timeout time of the time counter may be set according to a period in which the UE updates the stored authentication information. It should be understood that, in other specific embodiments, the RNC may start the timer or the time counter when the RNC is started.

Step 503: The UE performs communication with the RNC and sends identification information of the UE in the WLAN to the RNC.

Specifically, the UE may create a socket for describing an IP address and a port number, and send a request message to the RNC through a corresponding port, where the request message includes the identification information of the UE in the WLAN, such as a WLAN MAC address.

Step 504: After receiving the identification information in the WLAN, the RNC determines whether the started timer is triggered, or whether the time counter exceeds preset time, where the preset time may be set according to the period in which the UE updates the stored authentication information, if the timer is triggered or the time counter expires, executes step 505, and if the timer is not triggered or the time counter does not expire, ends the procedure.

Step 505: The RNC generates WLAN network authentication information corresponding to the identification information.

Specifically, for example, in this embodiment, WLAN network authentication information for the UE to use and WLAN network authentication information for the WLAN device to use may be generated. The WLAN network authentication information for the UE to use and the WLAN network authentication information for the WLAN device to use may be different, such as a private key. A network device in the WLAN may be a device such as an AC or an AP or a base station.

Step 506: The RNC sends correspondence between the generated WLAN network authentication information for the network device in the WLAN to use and the identification information to the WLAN device through an interface with the network device in the WLAN, and updates correspondence stored in the network device in the WLAN.

Specifically, the RNC may directly send the correspondence to an AP through an interface with the AP to update the stored correspondence, the RNC may also first send the correspondence to an AC through an interface with the AC, and then the AC forwards the correspondence to the AP to update the stored correspondence. In this case, the UE and the AP perform authentication of WLAN network access; the RNC may also send the correspondence to the AC to update the stored correspondence, and the AC and the UE perform authentication of WLAN network access.

Step 507: The RNC sends the generated WLAN network authentication information for the UE to use to the UE through the data transmission channel established in step 501.

Specifically, for example, the authentication information may be carried in a user plane message, a control plane message or a short message and sent to the UE; after receiving the WLAN network authentication information for the UE to use, the UE updates the stored authentication information by using the received authentication information.

Step 508: The UE configures an authentication file of the WLAN after receiving the authentication information, starts a WLAN function, and performs a process of asymmetric key authentication with the WLAN device.

Specifically, in an authentication process, a private key for the UE to perform encryption (or decryption) is different from a private key for the WLAN device to perform decryption (or encryption).

In this embodiment, the UE first accesses the UMTS network, and the RNC dynamically allocates different authentication information to the UE and the WLAN device to perform asymmetric key authentication, so that the authentication information in the authentication of network access is not easily leaked, thereby improving security.

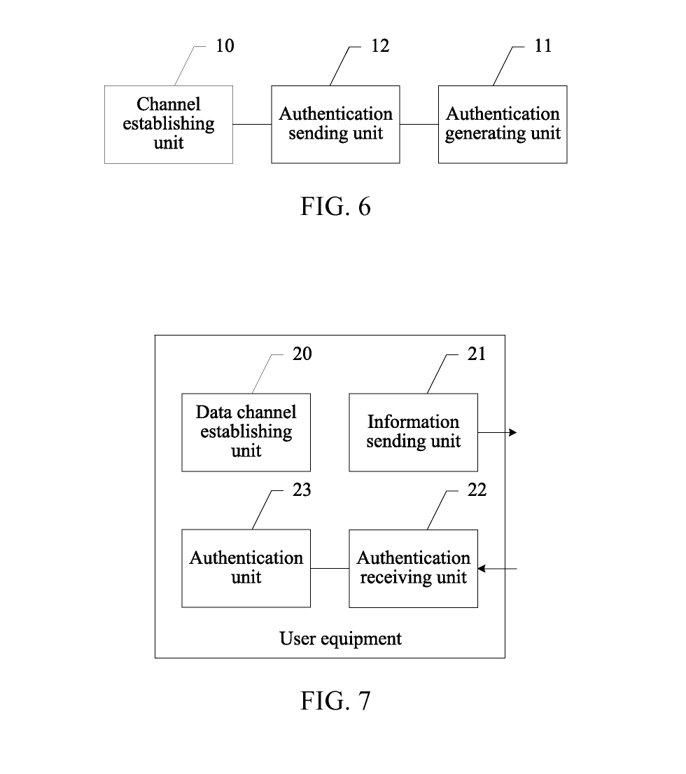

An embodiment of the present invention further provides a radio access network device, that is, a first radio access network device mentioned in the foregoing method embodiments, a schematic structural diagram of which is shown in FIG. 6. The radio access network device includes a number of units. A channel establishing unit 10 is configured to establish a data transmission channel of a first radio access network with a user equipment. The user equipment supports the first radio access network and a second radio access network.

An authentication generating unit 11 is configured to obtain identification information of the user equipment in the second radio access network, and to generate authentication information which is of the second radio access network and corresponds to the identification information. The authentication information includes authentication information which is of the second radio access network and is for the user equipment to use and authentication information which is of the second radio access network and is for a second radio access network device to use.

An authentication sending unit 12 is configured to send the authentication information which is of the second radio access network and is for the user equipment to use to the user equipment through the data transmission channel which is of the first radio access network and is established by the channel establishing unit 10, and to send correspondence between the identification information and the authentication information which is of the second radio access network and is for the second radio access network device to use to the second radio access network device.

Specifically, the authentication sending unit 12 may send the generated authentication information which is of the second radio access network and is for the user equipment to use to the user equipment through a user plane message, a control plane message or a short message.

In this embodiment, the first radio access network and the second radio access network do not represent a sequence relationship, but indicate a difference of radio access networks. For example, the first radio access network may be a cellular network, such as UMTS, GSM or LTE, and the second radio access network may be a WLAN; while the first radio access network device, for example, may be a radio network controller in a UMTS network, and the second radio access network device, for example, may be a device such as an access point or an access controller or a base station in a WLAN. Definitely, the first radio access network and the second radio access network may be any other two radio access networks.

It can be seen that, in the radio access network device in this embodiment, the channel establishing unit 10 establishes the data transmission channel of the first radio access network with the user equipment, the authentication generating unit 11 obtains the identification information of the user equipment in the second radio access network, and generates the authentication information which is of the second radio access network and corresponds to the identification information, and the authentication sending unit 12 sends the authentication information which is of the second radio access network and is for the user equipment to use to the user equipment through the established data transmission channel of the first radio access network, and sends the correspondence between the identification information and the authentication information which is of the second radio access network and is for the second radio access network device to use to the second radio access network device. When the user equipment accesses the second radio access network, the user equipment and the second radio access network device may perform authentication according to the authentication information. In this way, the authentication information for performing the authentication of the second radio access network no longer needs to be fixedly saved in the user equipment and the second radio access network device, but may be dynamically allocated by the first radio access network, so that the authentication information for performing network access authentication is not easily leaked, thereby improving security of network access authentication.

In a specific embodiment, besides including the structure shown in FIG. 6, the radio access network device may further include an authentication determining unit, configured to determine whether to generate the authentication information corresponding to the identification information, if yes, notify the authentication generating unit 11 of generating the authentication information, and the authentication sending unit 12 sends the authentication information. Specifically, the authentication determining unit may determine whether a preset time counter expires or determine whether a preset timer is triggered, if yes, determine to generate the authentication information for the user equipment, where timeout time of the preset time counter or timing time of the timer may be set according to a period in which the user equipment and the second radio access network device update the stored authentication information.

For a specific process of applying the radio access network device in the embodiment of the present invention to perform authentication, reference may be made to the foregoing method embodiments, and details are not repeatedly described herein.

An embodiment of the present invention further provides a user equipment, a schematic structural diagram of which is shown in FIG. 7. The user equipment includes a number of units. A data channel establishing unit 20 is configured to establish a data transmission channel of a first radio access network with a first radio access network device. An information sending unit 21 is configured to send identification information of a user equipment in a second radio access network to the first radio access network device. An authentication receiving unit 22 is configured to receive authentication information which is of the second radio access network, corresponds to the identification information, is for the user equipment to use, and is returned by the first radio access network device. An authentication unit 23 is configured to perform access authentication of the second radio access network according to the authentication information received by the authentication receiving unit 22, such as password authentication, key authentication, certificate authentication or identity authentication.

The first radio access network device may generate authentication information which is of the second radio access network and is for the user equipment to use and authentication information which is of the second radio access network and is for a second radio access network device to use, where the authentication information for the user equipment to use and the authentication information for the second radio access network device to use may be the same, for example, information such as a shared key, a certificate, an identity number or a password; and the authentication information for the user equipment to use and the authentication information for the second radio access network device to use may also be different, for example, information such as a private key.

In a specific embodiment, besides including the structure shown in FIG. 7, the radio access network device may further include an authentication querying unit, configured to query whether authentication information is locally stored, if yes, update the locally stored authentication information by using the authentication information received by the authentication receiving unit 22; and if not, store the authentication information received by the authentication receiving unit 22. Specifically, after the authentication receiving unit 22 receives the authentication information, the authentication querying unit performs querying and corresponding processing.

In this embodiment, the first radio access network and the second radio access network do not represent a sequence relationship, but indicate a difference of radio access networks. For example, the first radio access network may be a cellular network, such as UMTS, GSM or LTE, and the second radio access network may be a WLAN. While the first radio access network device, for example, may be a radio network controller in a UMTS network, and the second radio access network device, for example, may be a device, such as an access point or an access controller or a base station in a WLAN. Definitely, the first radio access network and the second radio access network may be any other two radio access networks.

In the user equipment in this embodiment, the data channel establishing unit 20 establishes the data transmission channel of the first radio access network with the first radio access network device, and the information sending unit 21 sends the identification information of the user equipment in the second radio access network to the first radio access network device; and after the authentication receiving unit 22 receives the returned authentication information which is of the second radio access network, is for the user equipment to use and corresponds to the identification information, the authentication unit 23 performs access authentication of the second radio access network according to the received authentication information. In this way, the authentication information for performing the authentication of the second radio access network no longer needs to be fixedly saved in the user equipment and the second radio access network device, but may be dynamically allocated by the first radio access network, so that the authentication information for performing network access authentication is not easily leaked, thereby improving security of network access authentication.

For a specific process of applying the user equipment in the embodiment of the present invention to perform authentication, reference may be made to the foregoing method embodiments, and details are not repeatedly described herein.

An embodiment of present invention further provides an authentication system for network access, where the authentication system includes: a first radio access network device and a second radio access network device.

The first radio access network device is configured to establish a data transmission channel of a first radio access network with a user equipment, obtain identification information of the user equipment in a second radio access network, generate authentication information which is of the second radio access network and corresponds to the identification information, where the authentication information includes authentication information which is of the second radio access network and is for the user equipment to use and authentication information which is of the second radio access network and is for the second radio access network device to use; send the authentication information which is of the second radio access network and is for the user equipment to use to the user equipment through the established data transmission channel of the first radio access network, and send correspondence between the identification information and the authentication information which is of the second radio access network and is for the second radio access network device to use to the second radio access network device.

The second radio access network device is configured to receive the correspondence which is between the authentication information which is of the second radio access network and is for the second radio access network device to use and the identification information and is sent by the first radio access network device, and perform access authentication of the second radio access network on the user equipment according to the received correspondence.

A structure of the first radio access network device may be the device structure in the embodiment corresponding to FIG. 6, and is not repeatedly described.

In this embodiment, the first radio access network and the second radio access network do not represent a sequence relationship, but indicate a difference of radio access networks. For example, the first radio access network may be a cellular network, such as UMTS, GSM or LTE, and the second radio access network may be a WLAN; while the first radio access network device, for example, may be a radio network controller in a UMTS network, and the second radio access network device, for example, may be a device, such as an access point or an access controller or a base station in a WLAN. Definitely, the first radio access network and the second radio access network may be any other two radio access networks.

In the authentication system in this embodiment, the first radio access network device establishes the data transmission channel of the first radio access network with the user equipment, obtains the identification information of the user equipment in the second radio access network, generates the authentication information which is of the second radio access network and corresponds to the identification information, where the authentication information includes the authentication information which is of the second radio access network and is for the user equipment and the second radio access network device to use; sends the authentication information which is of the second radio access network and is for the user equipment to use to the user equipment through the established data transmission channel of the first radio access network, and sends the correspondence between the identification information and the authentication information which is of the second radio access network and is for the second radio access network device to use to the second radio access network device, and the user equipment and the second radio access network device may perform authentication of the second radio access network according to the authentication information. In this way, the authentication information for performing the authentication of the second radio access network no longer needs to be fixedly saved in the user equipment and the second radio access network device, but may be dynamically allocated by the first radio access network, so that the authentication information for performing network access authentication is not easily leaked, thereby improving security of network access authentication.

For a specific process of applying the authentication system in the embodiment of the present invention to perform authentication, reference may be made to the foregoing method embodiments, and details are not repeatedly described herein.

Persons of ordinary skill in the art should understand that all or part of the steps in the methods in the foregoing embodiments may be implemented through a program instructing relevant hardware. The program may be stored in a computer readable storage medium, and the storage medium may includes a read only memory (ROM), a random access memory (RAM), a magnetic disk, an optical disk, or the like.

The authentication method, system and device for network access according to the embodiments of the present invention are described in detail in the foregoing. The principle and implementation manners of the present invention are described in the specification by applying specific examples. The description of the foregoing embodiments is merely provided for ease of understanding of the methods and the core ideas of the present invention. Meanwhile, persons of ordinary skill in the art may make variations to the specific implementation manners and application scopes according to the ideas of the present invention. To sum up, content of the specification shall not be construed as a limitation to the present invention.

What is claimed is:

1. An authentication method for network access, the method comprising:
establishing a data transmission channel of a first radio access network with a user equipment, wherein the user equipment supports the first radio access network and a second radio access network;
obtaining identification information of the user equipment in the second radio access network, and generating authentication information which is of the second radio access network and corresponds to the identification information, wherein the authentication information comprises authentication information which is of the second radio access network and is for the user equipment to use and authentication information which is of the second radio access network and is for a second radio access network device to use; and
sending the authentication information which is of the second radio access network and is for the user equipment to use to the user equipment through the established data transmission channel of the first radio access network, and sending correspondence between the identification information and the authentication information which is of the second radio access network and is for the second radio access network device to use to the second radio access network device.

2. The method according to claim 1, wherein the authentication information which is of the second radio access network and is for the user equipment to use and the authentication information which is of the second radio access network and is for the second radio access network device to use are the same or different.

3. The method according to claim 2, wherein a preset time counter expires or a preset timer is triggered and wherein before generating the authentication information which is of the second radio access network and corresponds to the identification information, the method further comprises determining to generate the authentication information, wherein timeout time of the preset time counter or timing time of the timer is set according to a period in which the user equipment and the second radio access network device update the stored authentication information.

4. The method according to claim 1, wherein after sending the correspondence between the identification information and the authentication information which is of the second radio access network and is for the second radio access network device to use to the second radio access network device, the method further comprises performing, by the second radio access network device, access authentication of the second radio access network on the user equipment according to the received correspondence.

5. The method according to claim 1, wherein the first radio access network is a cellular network and the second radio access network is a wireless local area network WLAN, wherein the second radio access network device is an access point AP or an access controller AC or a base station.

6. The method according to claim 1, wherein sending the authentication information which is of the second radio access network and is for the user equipment to use to the user equipment comprises sending the authentication information which is of the second radio access network and is for the user equipment to use to the user equipment through a user plane message, a control plane message or a short message.

7. An authentication method for network access, the method comprising:
establishing a data transmission channel of a first radio access network with a first radio access network device;
sending identification information of a user equipment in a second radio access network to the first radio access network device, wherein the user equipment supports the first radio access network and the second radio access network;
receiving authentication information of the second radio access network, corresponds to the identification information, is for the user equipment to use, and is returned by the first radio access network device; and
performing access authentication of the second radio access network according to the received authentication information.

8. The method according to claim 7, wherein after receiving the authentication information which corresponds to the identification information, is for the user equipment to use and is returned by the first radio access network device, the method further comprises querying whether the authentication information for the user equipment to use is locally stored, if yes, updating the locally stored authentication information by using the received authentication information; and if not, storing the received authentication information.

9. The method according to claim 7, wherein the first radio access network is a cellular network, the second radio access network is a wireless local area network WLAN, and the second radio access network device is an access point or an access controller or a base station.

10. A radio access network device, comprising:
a channel establishing unit, configured to establish a data transmission channel of a first radio access network with a user equipment, wherein the user equipment supports the first radio access network and a second radio access network;
an authentication generating unit, configured to obtain identification information of the user equipment in the second radio access network, and generate authentication information which is of the second radio access network and corresponds to the identification information, wherein the authentication information comprises authentication information which is of the second radio access network and is for the user equipment to use and authentication information which is of the second radio access network and is for a second radio access network device to use; and
an authentication sending unit, configured to send the authentication information which is of the second radio access network and is for the user equipment to use to the user equipment through the data transmission channel which is of the first radio access network and is established by the channel establishing unit, and send correspondence between the identification information and the authentication information which is of the second radio access network and is for the second radio access network device to use to the second radio access network device.

11. The radio access network device according to claim 10, further comprising an authentication determining unit, configured to, when a preset time counter expires or a preset timer is triggered, determine to generate the authentication information, and notify the authentication generating unit of generating the authentication information, wherein timeout time of the preset time counter or timing time of the timer is set according to a period in which the user equipment and the second radio access network device update the stored authentication information.

12. The radio access network device according to claim 10, wherein the authentication sending unit is further configured to send the authentication information which is of the second radio access network and is for the user equipment to use to the user equipment through a user plane message, a control plane message or a short message.

13. The radio access network device according to claim 10, wherein the first radio access network is a cellular network, and the second radio access network is a wireless local area network WLAN.

14. A user equipment, comprising:
a data channel establishing unit, configured to establish a data transmission channel of a first radio access network with a first radio access network device;
an information sending unit, configured to send identification information of the user equipment in a second radio access network to the first radio access network device, wherein the user equipment supports the first radio access network and the second radio access network;
an authentication receiving unit, configured to receive authentication information which is of the second radio access network, corresponds to the identification information, is for the user equipment to use, and is returned by the first radio access network device; and
an authentication unit, configured to perform access authentication of the second radio access network according to the authentication information received by the authentication receiving unit.

15. The user equipment according to claim 14, further comprising an authentication querying unit, configured to query whether authentication information is locally stored, if yes, update the locally stored authentication information by using the authentication information received by the authentication receiving unit; and if not, store the authentication information received by the authentication receiving unit.

16. The user equipment according to claim 14, wherein the first radio access network is a cellular network, and the second radio access network is a wireless local area network WLAN.
